(19) United States
(12) Patent Application Publication
(10) Pub. No.: US 2014/0118611 A1
(43) Pub. Date: May 1, 2014

(54) IMAGE PICKUP APPARATUS AND CONTROL METHOD THEREFOR

(71) Applicant: CANON KABUSHIKI KAISHA, Tokyo (JP)

(72) Inventor: Hideyuki HAMANO, Kawasaki-shi (JP)

(73) Assignee: CANON KABUSHIKI KAISHA, Tokyo (JP)

(21) Appl. No.: 14/064,441

(22) Filed: Oct. 28, 2013

(30) Foreign Application Priority Data
Oct. 29, 2012 (JP) 2012-237745
Oct. 18, 2013 (JP) 2013-217837

(51) Int. Cl. H04N 5/232

(52) U.S. Cl. CPC H04N 5/23212
USPC 348/350

(57) ABSTRACT

An image pickup apparatus that is capable of detecting focusing state with high accuracy even when a subject moves or a defocus condition varies. Focus detection zones are arranged like a lattice in first and second directions with respect to an image pickup device. A contrast focus evaluation value that evaluates image signals of pixels of the image pickup device corresponding to each focus detection zone in the second direction is generated. Focus of an image pickup optical system is adjusted based on the contrast focus evaluation value based on an image signal of a reliable focus detection zone. The focus detection zones are arranged so that one boundary of a first focus detection zone in the second direction is included within an area of a second focus detection zone in the second direction. The first and second focus detection zones are arranged and deviated in the first direction.

### BACKGROUND OF THE INVENTION

1. Field of the Invention

The present invention relates to an image pickup apparatus like a digital still camera or a digital video camera, and a control method therefor. In particular, the present invention relates to an image pickup apparatus that adjusts focus using an image signal outputted from an image pickup device, and a control method therefor.

2. Description of the Related Art

As an auto-focusing (referred to AF, hereafter) system in an image pickup apparatus like a digital still camera, there is a contrast AF system that detects an AF evaluation value signal corresponding to a contrast value of a subject by using an output signal from an image pickup device, such as a CCD sensor or a CMOS sensor, and focuses on the subject.

However, the contrast AF system has a problem of deterioration of focus detection performance because an AF evaluation value decreases and a ratio of noise component included in the output signal of the image pickup device increases, when a subject is in a low illumination condition or a low contrast condition.

Accordingly, a technique that divides an area on the image pickup device used for calculating the AF evaluation value into two or more focus detection zones and that calculates an edge decision evaluation value for each and every focus detection zone is proposed (see Japanese Laid-Open Patent Publication (Kokai) No. 2010-78810 (JP 2010-78810A)). The edge decision evaluation value is the total of the AF evaluation values detected while scanning a focus lens in the optical axis direction. A large edge decision evaluation value shows that there is an edge portion of the subject that enables focus detection in high accuracy in a divided focus detection zone.

Then, it is determined whether AF evaluation values of each focus detection zone are used for detecting focus detection using the edge decision evaluation value of the focus detection zone, and the overall AF evaluation value is obtained by accumulating the AF evaluation values of the focus detection zones that is determined to be used.

This increases the amount of information of the AF evaluation values, and improves focus detection performance when the subject is low in illumination or contrast.

However, the technique of the above-mentioned publication is difficult to perform accurate edge decision and to calculate an AF evaluation value with high reliability because the decision accuracy of the use propriety of each focus detection zone deteriorates when a subject moves while scanning the focus lens or when an optical image formed on the image pickup device moves due to variations of defocus condition and image magnification caused by driving the lens of the image pickup optical system.

Moreover, when focus detection zones that are used for the focus detection are selected from among focus detection zones arranged in horizontal and vertical directions like a lattice as disclosed in the above-mentioned publication, a movement and a variation of defocus condition of a general subject that has high contrast in the horizontal and vertical directions tends to give a large influence on the focus detection. Accordingly, the edge decision may be impossible or the AF evaluation values may not be obtained in many focus detection zones for a subject that has high contrast values in the vertical and horizontal directions, which may deteriorate the focus detection accuracy.

### SUMMARY OF THE INVENTION

The present invention provides a mechanism that is capable of performing focus detection with high accuracy even when a subject moves or a defocus condition varies during a focus detecting operation.

Accordingly, a first aspect of the present invention provides an image pickup apparatus comprising an image pickup device configured to photoelectrically convert an optical image formed by light entering through an image pickup optical system into an image signal, and to output the image signal, an arrangement unit configured to arrange a plurality of focus detection zones like a lattice in a first direction and a second direction that differs from the first direction with respect to the image pickup device, a generation unit configured to generate a contrast focus evaluation value that evaluates image signals of pixels of the image pickup device corresponding to each of the focus detection zones in the second direction, a reliability decision unit configured to determine reliability of each of the focus detection zones using the image signal, and a focusing unit configured to adjust focus of the image pickup optical system based on the contrast focus evaluation value unit based on an image signal of a focus detection zone of which reliability is more than a specified value among the focus detection zones, wherein the arrangement unit arranges the focus detection zones so that at least one boundary of a first focus detection zone in the second direction is included within an area of a second focus detection zone in the second direction, wherein the first and second focus detection zones are included in focus detection zones arranged in the first direction, wherein the first and second focus detection zones are deviated with one another in the first direction.

Accordingly, a second aspect of the present invention provides an image pickup apparatus comprising an image pickup device configured to photoelectrically convert an optical image formed by light entering through an image pickup optical system into an image signal, and to output the image signal, an arrangement unit configured to arrange a plurality of focus detection zones like a lattice in a first direction and a second direction that differs from the first direction with respect to the image pickup device, a generation unit configured to generate a contrast focus evaluation value that evaluates image signals of pixels of the image pickup device corresponding to each of the focus detection zones in the second direction, a reliability decision unit configured to determine reliability of each of the focus detection zones using the image signal, and a focusing unit configured to adjust focus of the image pickup optical system based on the contrast focus evaluation value based on an image signal of a focus detection zone of which reliability is more than a specified value among the focus detection zones, wherein the first and second focus detection zones that adjoin in the first direction among the focus detection zones are deviated with each other in the second direction.

Accordingly, a third aspect of the present invention provides a control method for an image pickup apparatus comprising an arrangement step of arranging a plurality of focus detection zones like a lattice in a first direction and a second direction that differs from the first direction with respect to an image pickup device, which photoelectrically converts an optical image formed by light entering through an image pickup optical system into an image signal, a generation step of generating a contrast focus evaluation value that evaluates image signals of pixels of the image pickup device corresponding to each of the focus detection zones in the second direction, a reliability decision step of determining reliability of each of the focus detection zones using the image signal, and a focusing step of adjusting focus of the image pickup optical system based on the contrast focus evaluation value based on an image signal of a focus detection zone of which reliability is more than a specified value among the focus detection zones, wherein the focus detection zones are arranged in the arrangement step so that at least one of two boundaries of a first focus detection zone in the second direction is included within an area of a second focus detection zone in the second direction, wherein the first and second focus detection zones are included in focus detection zones arranged in the first direction, wherein the first and second focus detection zones are deviated with one another in the first direction.

Accordingly, a fourth aspect of the present invention provides a control method for an image pickup apparatus comprising an arrangement step of arranging a plurality of focus detection zones like a lattice in a first direction and a second direction that differs from the first direction with respect to an image pickup device, which photoelectrically converts an optical image formed by light entering through an image pickup optical system into an image signal, a generation step of generating a contrast focus evaluation value that evaluates image signals of pixels of the image pickup device corresponding to each of the focus detection zones in the second direction, a reliability decision step of determining reliability of each of the focus detection zones using the image signal, and a focusing step of adjusting focus of the image pickup optical system based on the contrast focus evaluation value based on an image signal of a focus detection zone of which reliability is more than a specified value among the focus detection zones, wherein the first and second focus detection zones that adjoin in the first direction among the focus detection zones are deviated with each other in the second direction.

According to the present invention, the focus detection with high accuracy can be performed even when a subject moves or a defocus condition varies during a focus detecting operation.

Further features of the present invention will become apparent from the following description of exemplary embodiments with reference to the attached drawings.

### BRIEF DESCRIPTION OF THE DRAWINGS

FIG. 1 is a block diagram schematically showing an outline configuration example of a digital still camera as an example of an image pickup apparatus according to a first embodiment of the present invention.

FIG. 2 is a flowchart showing an AF operation of the digital still camera shown in FIG. 1.

FIG. 3A is a view showing an arrangement of focus detection zones within an image pickup screen set by a focusing device with which the digital still camera shown in FIG. 1 is provided. FIG. 3B is a view showing an arrangement of focus detection zones within an image pickup screen set by a focusing device of a comparative example to FIG. 3A.

FIG. 4A is an enlarged view of the entire focus detection area shown in FIG. 3A, and FIG. 4B is an enlarged view of the entire focus detection area shown in FIG. 3B.

FIG. 5 is a flowchart showing a concrete process of the reliability assessment for each focus detection zone in the step S3 in FIG. 2.

FIG. 6A and FIG. 6B are views showing images formed on the image pickup screen of the digital still camera shown in FIG. 1. FIG. 6A shows a state that focuses on the farthest point, and FIG. 6B shows a state that focuses on a point nearer than the focused point in FIG. 6A.

FIG. 7A and FIG. 7B are views showing images formed on the image pickup screen of the digital still camera shown in FIG. 1. FIG. 7A shows a state that focuses on a point nearer than the focused point in FIG. 6B, and FIG. 7B shows a state that focuses on a point nearer than the focused point in FIG. 7A.

FIG. 8A is a graph showing a relationship between a position of a focus lens group and a focus evaluation value in the digital still camera shown in FIG. 1. FIG. 8B is a graph showing a relationship between a position of the focus lens group and a luminance-signal difference value in the digital still camera shown in FIG. 1.

FIG. 9 is a flowchart showing a concrete process of perspective conflict decision for each focus detection zone group in the step S4 in FIG. 2.

FIG. 10 is a graph showing a relationship between an AF evaluation value of a focus detection zone group and a position of the focus lens group in the digital still camera shown in FIG. 1.

FIG. 11A is a view showing focus detection zones that are not extracted from the focus detection zones shown in FIG. 3A in the steps S3 and S4 in FIG. 2. FIG. 11B is a view showing focus detection zones that are not extracted from the focus detection zones shown in FIG. 3B in the steps S3 and S4 in FIG. 2.

FIG. 12A and FIG. 12B are views showing modifications of the focus detection zones in the digital still camera shown in FIG. 1.

FIG. 13 is a view showing an arrangement of focus detection zones within an image pickup screen in a digital still camera that is provided with a focusing device according to a second embodiment of the present invention.

FIG. 14 is a flowchart showing an AF operation of a digital still camera that is provided with a focusing device according to a third embodiment of the present invention.

FIG. 15A is a view showing an example of an arrangement of focus detection zones within an image pickup screen in a digital still camera that is provided with a focusing device according to a fourth embodiment of the present invention, and FIG. 15B is a view showing a comparative example of an arrangement of focus detection zones.

### DESCRIPTION OF THE EMBODIMENTS

Hereafter, embodiments according to the present invention will be described in detail with reference to the drawings.

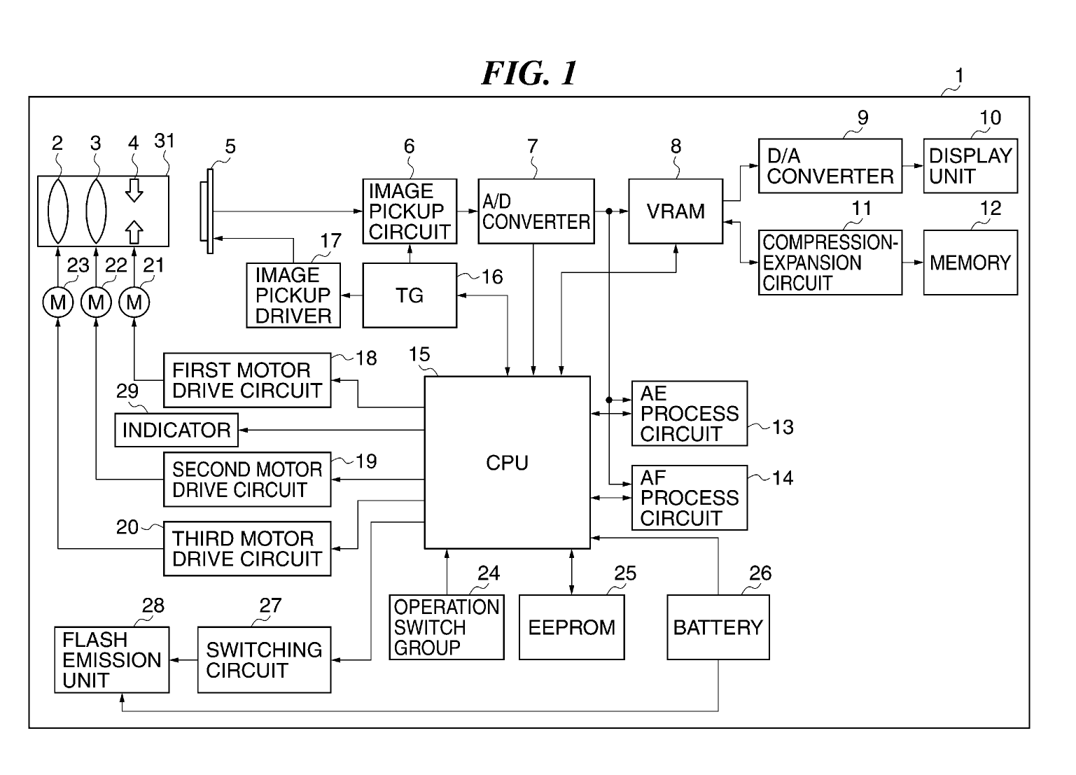

FIG. 1 is a block diagram schematically showing an outline configuration example of a digital still camera as an example of an image pickup apparatus according to a first embodiment of the present invention. It should be noted that the present invention can be applied to an apparatus that focuses on a subject using an image signal outputted from an image pickup device and is not limited to a digital still camera that this embodiment exemplifies as an image pickup apparatus.

As shown in FIG. 1, the digital still camera 1 is provided with a lens barrel 31 containing an image pickup optical system that consists of a zoom lens group 2, a focus lens group 3, a diaphragm 4, etc.

An image pickup device 5 consists of a CCD sensor, a CMOS sensor, etc., converts photoelectrically an optical image formed by light entering through the image pickup optical system, and outputs an image signal.

An image pickup circuit 6 generates a specified image signal by applying various kinds of image processes to the image signal converted photoelectrically by the image pickup device 5. An A/D converter 7 converts the analog image signal generated by the image pickup circuit 6 into a digital image signal.

A VRAM 8 stores temporarily the digital image signal outputted from the A/D converter 7. A D/A converter 9 reads the image signal stored in the VRAM 8, converts it into an analog signal, and converts the analog signal into an image signal suitable for a reproducing output.

A display unit 10 consists of an LCD etc., and displays a taken image and focus detection frames that show focus detection zones at the time of an AF operation mentioned later. A memory 12 consists of a semiconductor memory etc., and stores image data.

A compression-expansion circuit 11 reads the image signal stored temporarily in the VRAM 8, and applies a compression process and an expansion process to the image data so as to be suitable for storing into the memory 12. Moreover, the compression-expansion circuit 11 reads the image data stored in the memory 12, applies a compression process or an expansion process to the image data, and writes the image data after processing into the memory 12 again.

An AE process circuit 13 performs an automatic exposure (AE) process in response to the output from the A/D converter 7. A scan AF process circuit 14 performs an AF process in response to the output from the A/D converter 7. A CPU 15 has a built-in memory for calculation, and controls the whole camera. A TG (timing generator) 16 supplies a specified timing signal to the image pickup circuit 6 and an image pickup driver 17.

A first motor drive circuit 18 controls a diaphragm drive motor 21 that drives the diaphragm 4. A second motor drive circuit 19 controls a focus drive motor 22 that drives the focus lens group 3. A third motor drive circuit 20 controls a zoom drive motor 23 that drives the zoom lens group 2.

An EEPROM 25 is an electrically rewritable read-only memory in which data used to perform various control programs and various operations are beforehand stored. A switching circuit 27 controls a flash emission by a flash emission unit 28. A battery 26 supplies electric power to the CPU 15 and the flash emission unit 28. An indicator 29 is an LED etc. and displays OK and NG of the AF operation.

An operation switch group 24 includes a main power switch, a release switch, a reproduction switch, a zoom switch, a switch for turning ON/OFF of a display of an AF evaluation value signal on a monitor, etc.

The main power switch starts the camera and supplies electric power from the battery 26. The release switch makes a taking operation (a storage operation) etc. start. The release switch is a two-step switch that has a first stroke for generating an instruction signal that makes the AE process and the AF process start in advance of a taking operation, and a second stroke for generating an instruction signal that makes an actual exposure operation start. The reproduction switch makes a reproduction operation start. The zoom switch makes the zoom lens group 2 of the image pickup optical system move.

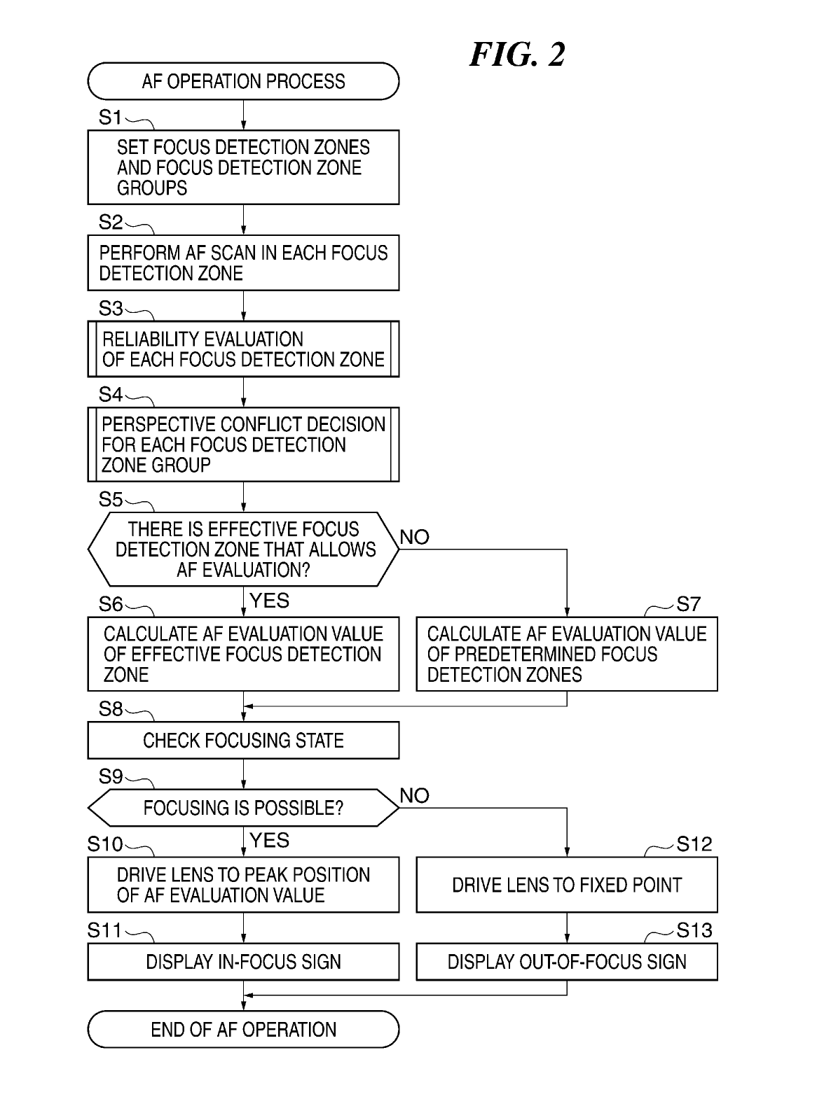

FIG. 2 is a flowchart showing the AF operation of the digital still camera 1. Each process in FIG. 2 is achieved by loading a control program stored in the ROM etc. onto a RAM and by executing the program by the CPU 15.

When the AF operation process in FIG. 2 is started, the CPU 15 sets up focus detection zones and focus detection zone groups for focusing on a subject in step S1, and proceeds with the process to step S2. In the process in this step S1, M rectangular focus detection zones (M=m_h*m_v (m_h=1, 2, . . . , m_v=1, 2, . . . )) are arranged like a lattice in an image pickup screen. The setting of the focus detection zone groups will be mentioned later. It should be noted that the word “lattice” in this specification means the state where a plurality of zones are arranged without gaps, and includes the case where boundaries are deviated with one another among lines or columns.

In each focus detection zone, a plurality of pickup pixels are two-dimensionally arranged in the line direction and the column direction. The number of the pickup pixels arranged in each focus detection zone is identical.

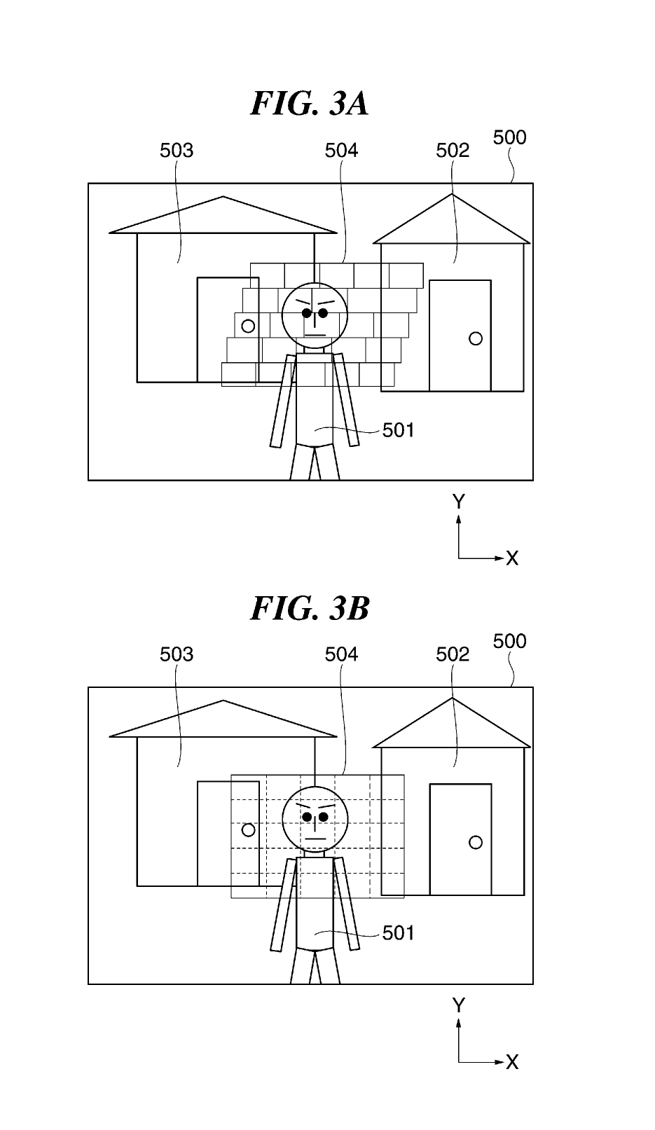

FIG. 3A is a view showing an arrangement of focus detection zones within an image pickup screen set by a focusing device with which the digital still camera 1 is provided. In this example, the entire focus detection area 504 that is divided into M (=5 lines*5 columns) zones is set up in the center in the image pickup screen 500, and the positions of the respective lines are deviated with one another in an X direction (the horizontal direction). The deviation amount between different lines in the X direction is set so as to be integral multiple of a width that is obtained by dividing the width of one focus detection zone by the number of lines (=5).

The entire focus detection area 504 is a range in which the image signal for focusing is evaluated by the AF process mentioned later. An object of the AF process is to focus on a subject intended by a photographer within the entire focus detection area 504. The positions, the size, and the number of the focus detection zones are not limited by the example shown in FIG. 3A. They can be set arbitrarily.

In addition, the deviation amount and the division number (the number of focus detection zones) may be changed according to a subject. When the division number is maintained in the case where the size of a subject is small, the size of each focus detection zone becomes small, which may deteriorate an S/N ratio of the focus evaluation value obtained. Accordingly, the minimum area of the focus detection zone may be set and the division number may be set so that the focus detection zone is larger than the minimum area. The deviation amount may be changed according to the set division number.

FIG. 3B is a view showing a comparative example in which the entire focus detection area 504 that is divided into M (=5*5) pieces of zones is set in the center of the image pickup screen 500 as with the above-mentioned patent publication. It should be noted that the comparison between FIG. 3A and FIG. 3B will be mentioned later.

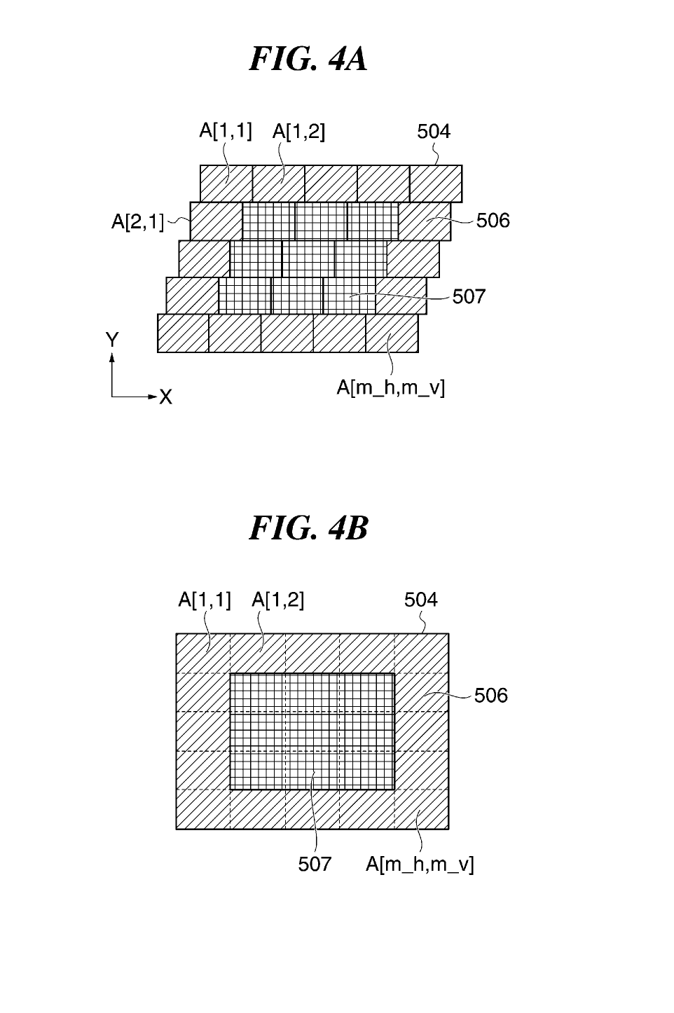

FIG. 4A is an enlarged view of the entire focus detection area 504 shown in FIG. 3A. FIG. 4B is an enlarged view of the entire focus detection area 504 shown in FIG. 3B. As shown in FIG. 4A, the focus detection zones A[h, v] (h=1, 2, . . . , m_h, v=1, 2, . . . , m_v) represent small focus detection zones that are formed by dividing the entire focus detection area 504.

Here, two focus detection zones that stand at positions different in the vertical direction (Y direction) among the focus detection zones A[h, v] are equivalent to first and second focus detection zones included in a plurality of focus detection zones that are arranged side by side in the first direction according to the present invention. The vertical direction (the Y direction (the column direction)) in FIG. 4A is equivalent to the first direction of the present invention, and the horizontal direction (the X direction (the line direction)) in FIG. 4A is equivalent to the second direction of the present invention that is different from the first direction.

When the zones A[1, 1] and A[2, 1] are assumed as the first and second focus detection zones, the left boundary of the zone A[1, 1] in the X direction is included within the width of the zone A[2, 1] in the X direction. That is, at least one of the two boundaries of the first focus detection zone in the second direction is included within the width of the second focus detection zone in the second direction.

Moreover, in the step S1, the CPU 15 sets an outer peripheral focus detection zone group 506 that is hatched with a bias pattern and a central focus detection zone group 507 that is hatched with a latticed pattern as shown in FIG. 4. These focus detection zone groups 505 and 507 are used to determine whether there are subjects at points that are different in distance from the camera in the entire focus detection area 504 (perspective conflict decision). Details will be described below.

Since there is high probability that a subject on which a photographer wants to focus is located in the center region of the entire focus detection area 504, the focus detection zone groups are set at the center and the periphery in this embodiment. However, the setting of the groups is not limited to the method in this embodiment. For example, when sizes and positions of faces have been known by detecting a subject, focus detection zone groups should be arranged according to the sizes and positions.

The CPU 15 performs an AF scan (a focus detecting operation) in each of the focus detection zones set in the step S1 in step S2, and proceeds with the process to step S3. In the AF scan, the CPU 15 moves the focus lens group 3 stepwise by specified moving amount from an AF-scan start position to an AF-scan end position, and performs the focus detecting operation at each position. Then, the CPU 15 makes the scan AF processing circuit 14 generate contrast focus evaluation values and luminance-signal difference values at each position of the focus lens group 3, and stores the generated values.

Here, the focus evaluation values shall be represented by E[n][h, v] (n=0, 1, 2, . . . , N−1, h=1, 2, . . . , m_h, v=1, 2, . . . , m_v). Moreover, the luminance-signal difference values shall be represented by D[n][h, v] (n=0, 1, 2, . . . , N−1, h=1, 2, . . . , m_h, v=1, 2, . . . , m_v).

The focus evaluation value E[n][h, v] represents the focus evaluation value in the focus detection zone A[h, v] when the focus lens group 3 is positioned at the n-th step from the AF-scan start position. Moreover, the number of steps (scanning points) at which the focus detecting operations are performed from the AF-scan start position to the AF-scan end position is set to N.

The scan AF processing circuit 14 calculates the focus evaluation value E by applying arithmetic processes, such as accumulation, to high-frequency components that are extracted through a high pass filter etc. from the inputted image signals in the focus detection zone A[h, v]. The focus evaluation value E calculated in this way corresponds to the amount of outline components in high spatial frequency in the image signal in the focus detection zone A[h, v], decreases in a defocus condition, and is maximized in a in-focus condition.

It should be noted that the focus evaluation value E may be calculated by using the values of the high-frequency components of one typical line (a line of pixels) in the focus detection zone A[h, v]. For example, the line that the value of high-frequency component is largest is used as the typical line. Moreover, the focus evaluation value E may be calculated by using the integration value of the high-frequency components of all the lines in the focus detection zone A[h, v].

The luminance-signal difference value D[n][h, v] represents the luminance-signal difference value in the focus detection zone A[h, v] when the focus lens group 3 is positioned at the n-th step from the AF-scan start position. Moreover, the number of steps (scanning points) at which the luminance-signal difference values are detected from the AF-scan start position to the AF-scan end position is set to N. The luminance-signal difference value D[n][h, v] is an evaluation value for detecting a motion of the subject in the focus detection zone A[h, v] during the AF scan.

For example, the scan AF processing circuit 14 calculates the luminance-signal difference value D in the focus detection zone A[h, v] according to the following formula (1) using the inputted image signal.

$$D [ n ] [ h , v ] = {\sum }_{l = 1}^{L} ( max [ h , v ] ( l ) - min [ h , v ] ( l ) ) \qquad ( 1 )$$

In the above formula (1), max[h, v] (l) and min[h, v] (l) represent the maximum value and the minimum value of luminance signals of pixels in hl-th line among L lines of pixels that constitute the focus detection zone A[h, v].

In the above formula (1), the difference between the maximum value and the minimum value of the luminance signals is calculated for every line, and the total sum of the calculated differences for all the lines in the focus detection zone is calculated as the luminance-signal difference value D [n][h, v]. Here, the image signal may be used as the luminance signal as-is, or may be used after removing high frequency noise by applying a low pass filtering process to the image signal.

Although the luminance-signal difference value D is obtained as the integrated value of the difference between the maximum value and the minimum value of the luminance signals of each line in this embodiment, a calculation method is not limited to this. For example, the difference between the maximum value and the minimum value of luminance signals are calculated for every line, and the maximum value of the difference values of all the lines may be used as the luminance-signal difference value D. Moreover, the luminance-signal difference value D is also calculated in the direction in which the high-frequency components are extracted as the focus evaluation value E.

The luminance-signal difference value D calculated using the above formula (1) is hardly affected by the variation of focusing state of the outline of the subject, but is affected when the minimum value and the maximum value of the luminance signals in the focus detection zone newly vary during the AF scan.

The minimum value and the maximum value of the luminance signals in the focus detection zone A[h, v] vary with movement of a subject and variation of defocus condition. That is, the luminance-signal difference value D varies when the luminance signals in the focus detection zone vary with movement of a subject and variation of defocus condition.

The CPU 15 calculates the reliability evaluation value of each focus detection zone in step S3, and proceeds with the process to step S4. The reliability evaluation value calculated here is used to eliminate an influence on the AF due to movement of a subject during the AF scan performed in the step S2, and to eliminate an influence on the AF given by a subject outside the focus detection zone due to variations of image magnification and defocus.

The large reliability evaluation value means that the above phenomena during the AF scan give large influence on the AF (the reliability of the focus detection zone is low). It should be noted that details of the method of reliability-evaluation-value calculation for a focus detection zone will be mentioned later.

The CPU 15 performs the perspective conflict decision for each focus detection zone group in the step S4, and proceeds with the process to step S5. Here, the CPU 15 calculates the positions of the focus lens group 3 where the focus evaluation values of the focus detection zone groups 506 and 507 shown in FIG. 4A reach the respective peaks (maximized), i.e., the in-focus positions.

Then, the CPU 15 determines whether the perspective conflict occurs in the entire focus detection area 504 by comparing the in-focus positions of the focus detection zone groups 506 and 507, and determines the focus detection zone group in which a main subject exists. It should be noted that details of the method of the perspective conflict decision between the focus detection zone groups will be mentioned later.

In the step S5, the CPU 15 determines whether there is an effective focus detection zone that was evaluated to have the reliability higher than the specified value in the step S3 and that constitutes the focus detection zone group that was determined to include the main subject in the step S4. It should be noted that it may be determined that there are effective focus detection zones only when the number of the effective focus detection zones is larger than a specified threshold. Then, when there is an effective focus detection zone that allows an AF evaluation, the CPU 15 proceeds with the process to step S6.

The CPU 15 calculates an AF evaluation value of the effective focus detection zone in the step S6, and proceeds with the process to step S8. The CPU 15 calculates the AF evaluation value using the focus evaluation value E obtained in the step S2 without driving the focus lens group 3 again.

The AF evaluation value AF_V[n] represents the focusing state of the entire focus detection area 504 when the focus lens group 3 is positioned at the n-th step from the AF-scan start position, and increases as the focusing state is closer to an in-focus condition.

In this embodiment, the entire focus detection area 504 is divided into a plurality of focus detection zones, and the focus evaluation value E is calculated for each focus detection zone. Since the focus evaluation value E decreases in a defocus condition and maximizes in the in-focus condition as mentioned above, the AF evaluation value AF_V[n], which is calculated as the total sum of the focus evaluation values E, has the similar tendency.

Moreover, when the number of the scanning points from the AF-scan start position to the AF-scan end position is N and the number of the effective focus detection zones that are determined to enable the AF evaluation in the step S5 is AF_Num, the AF evaluation value AF_V[n] is calculated according to the following formula (2).

$$AF\_V [ n ] = {\sum }_{h = 1}^{m\_h} {\sum }_{v = 1}^{m\_v} E [ n ] [ h , v ] / AF\_Num \qquad ( 2 )$$

The above formula (2) is calculated on the precondition that the focus evaluation values E[n][h, v] of focus detection zones other than the focus detection zones that were evaluated to have the reliability in the step S3 and that were determined to be included in the available focus detection zone group in the step S4 are set to 0. Furthermore, the total sum of the focus evaluation values is normalized by the number AF_Num of the effective focus detection zones that are determined to enable the AF evaluation. Thereby, the AF evaluation value can be obtained stably regardless of the number AF_Num of the effective focus detection zones that allow the AF evaluation.

That is, the AF evaluation value is normalized by dividing the total sum of the focus evaluation values E by the number of the focus detection zones determined to be used for focusing.

Moreover, although this embodiment accumulates the focus evaluation values to calculate the AF evaluation value, the calculation method is not limited to this. For example, when the focus detection zones at the center region of the entire focus detection area have priority, weighing may be performed so that the focus evaluation values of the focus detection zones at the center region are larger than the focus evaluation values of other focus detection zones. The present invention includes the method for calculating the AF evaluation value as the total sum of the focus evaluation values and the method for calculating the AF evaluation value as the total sum of the focus evaluation values after the above-mentioned weighting.

On the other hand, when the CPU 15 determines, in the step S5, that there is no effective focus detection zone that was evaluated to have the high reliability in the step S3 and that is included in the focus detection zone group including the main subject in the step S4, the CPU 15 proceeds with the process to step S7.

The CPU 15 calculates the AF evaluation values of the predetermined focus detection zones in the entire focus detection area 504 in the step S7, and proceeds with the process to step S8. Here, the CPU 15 calculates the total sum of all the focus evaluation values E[n][h, v] of the twenty five focus detection zones shown in FIG. 4A as the AF evaluation value, for example. When the center region is regarded as more important than the peripheral region, nine focus detection zones of 3*3 in the center region may be used. The focus detection zones to be used are not limited to these examples.

The CPU 15 checks the focusing state in the step S8, and proceeds with the process to step S9. Here, the CPU 15 determines whether there is a local maximum of the AF evaluation values corresponding to the position of the focus lens group 3, and calculates the position of the focus lens group 3 corresponding to the local maximum if possible. Furthermore, the CPU 15 evaluates the reliability of the change curve of the AF evaluation values near the local maximum. This reliability evaluation determines whether the calculated AF evaluation value takes the local maximum because an optical image of a subject is formed on the image pickup device 5 or because of other disturbance.

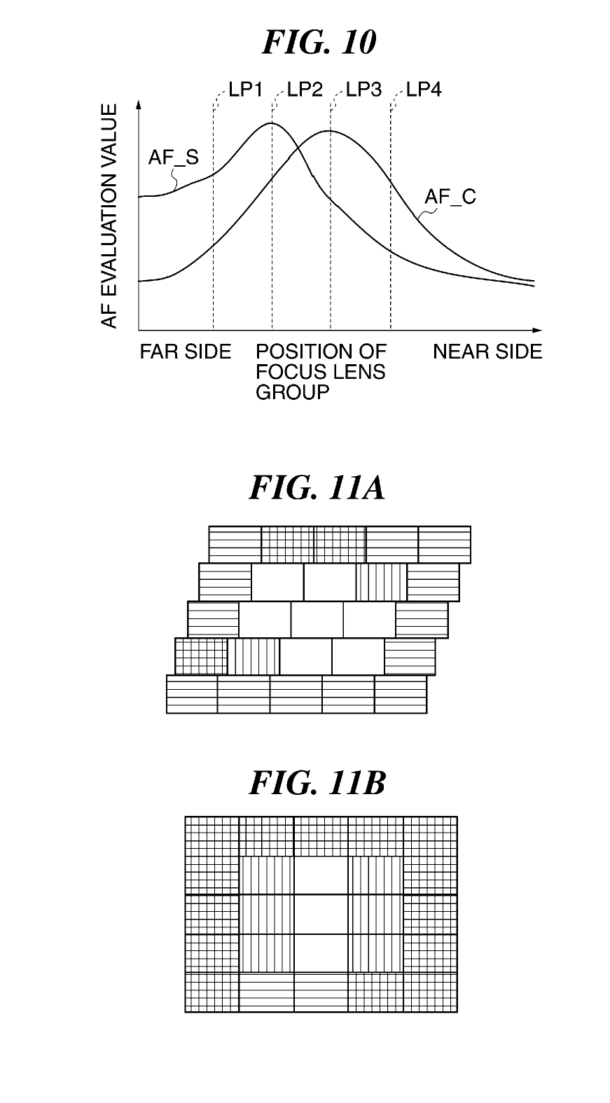

Specifically, a well-known focusing state checking method may be used (for example, see FIG. 10 through FIG. 13 of JP 2010-78810A mentioned above). That is, it is determined whether the AF evaluation values showing a focusing state varies like a mountain shape based on the difference between the maximum value and the minimum value of the AF evaluation values, the length of a slope section with an inclination beyond a specific value (SlopeThr), and the gradient of the slope section. Thereby, the focusing state can be determined.

The CPU 15 determines whether focusing is possible in the step S9 based on the focusing state checking in the step S8. When determining that the focusing is possible, the CPU 15 proceeds with the process to step S10. When determining that the focusing is impossible, the CPU 15 proceeds with the process to step S12.

The CPU 15 calculates the peak position based on the AF evaluation values in the step S10, drives the focus lens group 3 to the peak position, and proceeds with the process to step S11.

The CPU 15 displays an in-focus sign in the step S11, and finishes this AF operation process.

On the other hand, the CPU 15 drives the focus lens group 3 to a predetermined position called a fixed point at which the lens focuses on a subject in high probability, and proceeds with the process to step S13.

The CPU 15 displays an out-of-focus sign in the step S13, and finishes this AF operation process.

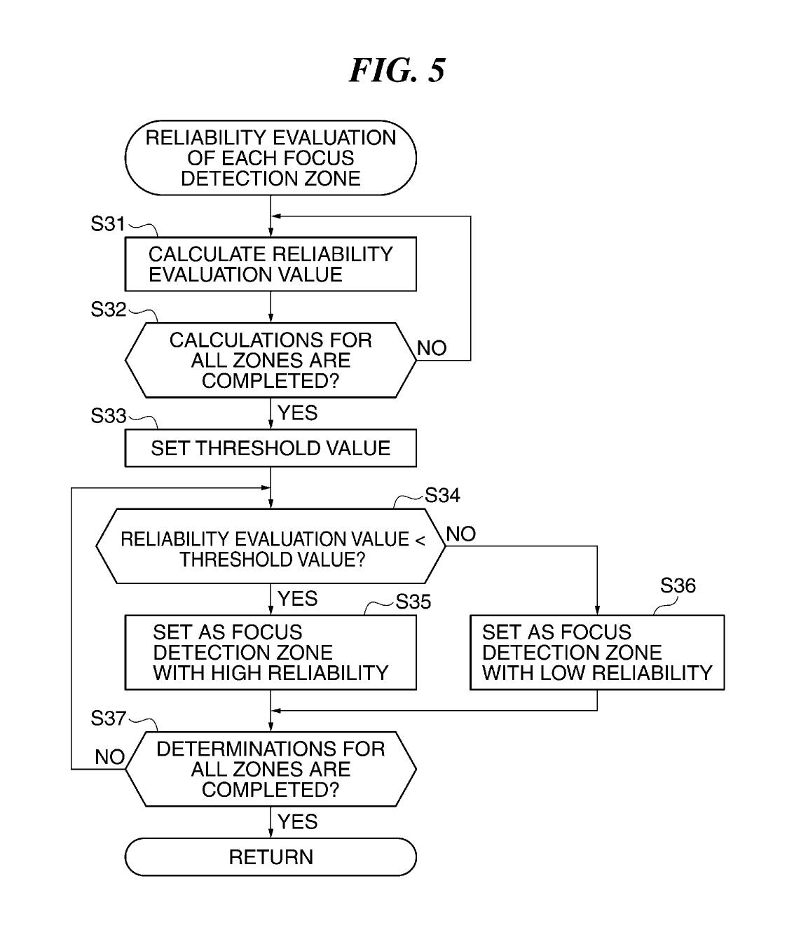

Next, the concrete process of the reliability evaluation of each focus detection zone in the step S3 in FIG. 2 will be described with reference to FIG. 5.

The CPU 15 calculates the reliability evaluation value R[h, v] in step S31, and proceeds with the process to step S32. Here, the reliability evaluation value R[h, v] is used to determine whether each focus detection zone is affected by an influence on the AF due to movement of a subject during AF scan and an influence on the AF given by a subject outside the focus detection zone due to variations of image magnification and defocus. The reliability evaluation value R[h, v] is calculated as an amount of change of the luminance-signal difference value D[n][h, v] in the focus detection zone A[h, v] during AF scan according to the following formula (3).

R[h,v]=max(D[n][h,v]−D[n−l][h,v])(n≧2) (3)

The reliability evaluation value R[h, v] calculated according to the above formula (3) is the maximum value of the amount of change of the luminance-signal difference value D[n][h, v] with the movement of the focus lens group 3 during AF scan.

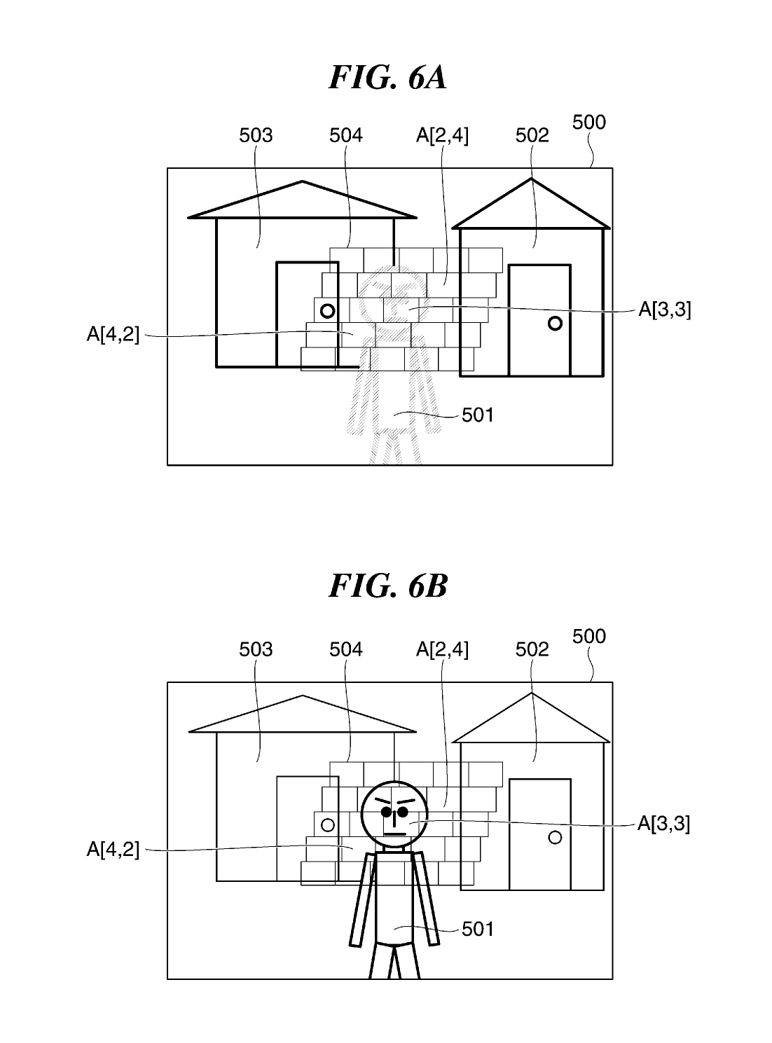

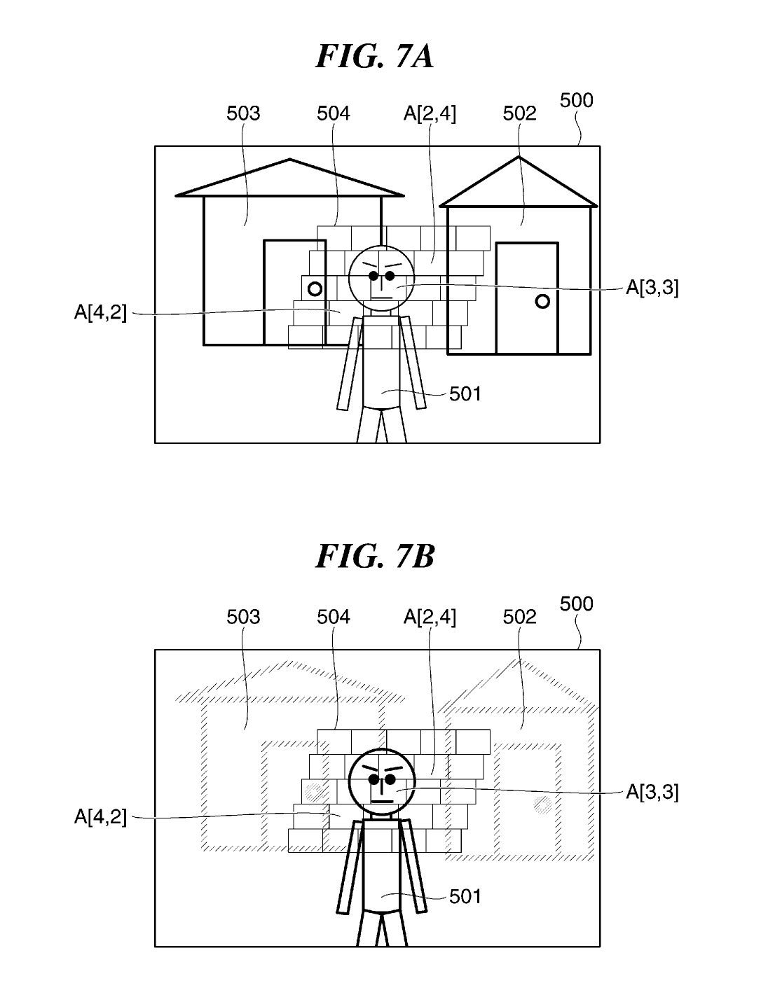

A reason why the above-mentioned reliability evaluation value R[h, v] is used for determining whether each focus detection zone is affected by an influence on the AF due to movement of a subject during AF scan and an influence on the AF given by a subject outside the focus detection zone due to variations of image magnification and defocus will be described with reference to FIG. 6A, FIG. 6B, FIG. 7A, and FIG. 7B.

FIG. 6A, FIG. 6B, FIG. 7A, and FIG. 7B are views schematically showing variations of the image pickup screen 500 shown in FIG. 3A according to the movement of the focus lens group 3 during AF scan.

FIG. 6A shows a state that focuses on the farthest subject among FIG. 6A, FIG. 6B, FIG. 7A, and FIG. 7B. In FIG. 6A, a person 501 and houses 502 and 503, which are main subjects, are in a defocus condition.

FIG. 6B shows a state that focuses on a point nearer than the focused point in FIG. 6A. In FIG. 6B, the houses 502 and 503 are mainly in the in-focus condition, while the person 501 are still in a defocus condition.

FIG. 7A shows a state that focuses on a point nearer than the focused point in FIG. 6B. In FIG. 7A, the person 501 as the main subject is mainly in the in-focus condition, while the houses 502 and 503 are in a defocus condition.

FIG. 7B shows a state that focuses on a point nearer than the focused point in FIG. 7A. In FIG. 7B, all the subjects in the image pickup area 500 are blurred while the defocus conditions are different for the subjects.

As shown in FIG. 6A through FIG. 7B, as the focused point moves from the far side to the near side, the houses 502 and 503 move toward the center of the image pickup area due to the variation of the image magnification of the image pickup optical system. Such movement of the subject during AF scan spoils the reliability of the focus evaluation value obtained in the focus detection zone. This embodiment reduces the influence due to such movement of the subject by devising arrangement of the focus detection zones. Hereinafter, the details will be described.

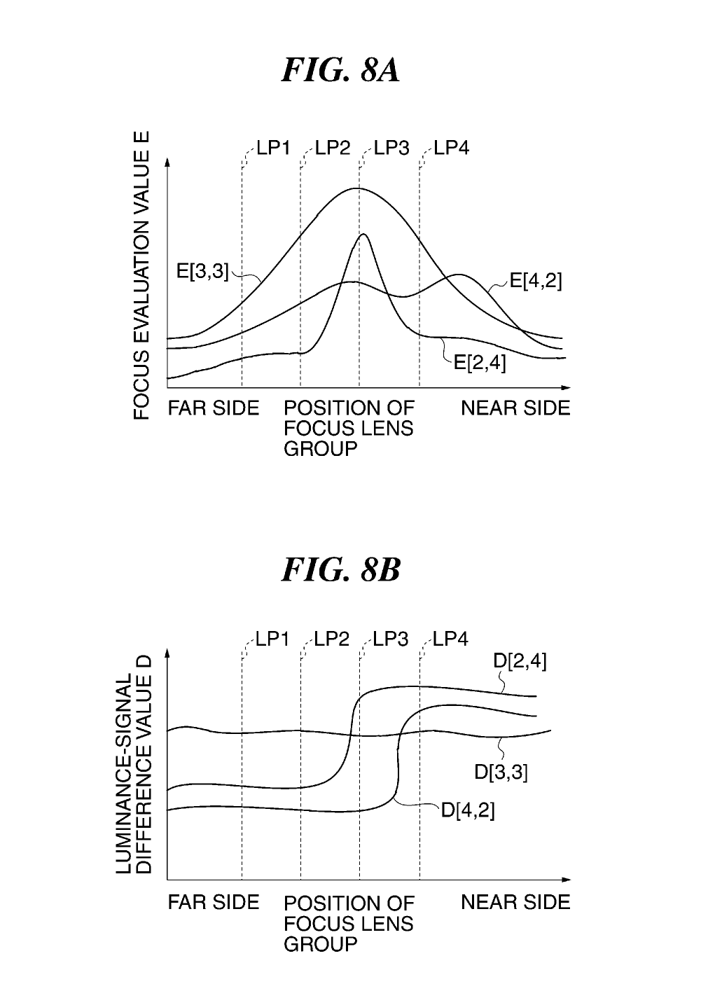

The focus evaluation value E and the luminance-signal difference value D of the focus detection zone A in the conditions shown in FIG. 6A through FIG. 7B are shown in FIG. 8A and FIG. 8B. In this embodiment, FIG. 8A shows the focus evaluation values E of the focus detection zones A[2, 4], A[3, 3], and A[4, 2] as representative examples, and FIG. 8B shows the luminance-signal difference values D.

FIG. 8A is a graph showing the relationship between the position of the focus lens group 3 and the focus evaluation value E. The curves E[2, 4], E[3, 3], and E[4, 2] in FIG. 8A represent variations of the focus evaluation values E of the focus detection zones A[2, 4], A[3, 3], and A[4, 2], respectively. Moreover, lens positions LP1, LP2, LP3, and LP4 correspond to the positions of the focus lens group 3 shown in FIG. 6A, FIG. 6B, FIG. 7A, and FIG. 7B, respectively.

FIG. 8B is a graph showing the relationship between the position of the focus lens group 3 and the luminance-signal difference value D. The curves D[2, 4], D[3, 3], and D[4, 2] in FIG. 8B represent variations of the luminance-signal difference values D of the focus detection zones A[2, 4], A[3, 3], and A[4, 2], respectively. Moreover, lens positions LP1, LP2, LP3, and LP4 correspond to the positions of the focus lens group 3 at the states shown in FIG. 6A, FIG. 6B, FIG. 7A, and FIG. 7B, respectively.

In the focus detection zone A[2, 4], since none of outlines of the person 501 and the house 502 is included in the area in the state shown in FIG. 6A, the focus evaluation value E[2, 4] takes a very small value. However, since the outline of the house 502 enters in the focus detection zone A[2, 4] as the focused point comes nearer, the focus evaluation value E[2, 4] increases rapidly.

When the camera focuses on the house 502 in the state shown in FIG. 6B, the outline of the house 502 starts entering in the focus detection zone A[2, 4]. Accordingly, the focus evaluation value E[2, 4] takes the local maximum value near the lens position LP3 where the outline of the house 502 has completely entered in the focus detection zone A[2, 4], not at the lens position LP2 where the house 502 is in an in-focus condition. Then, the focus evaluation value E[2, 4] decreases as the outline of the house 502 is blurred.

On the other hand, while the outline of the house 502 has not entered in the focus detection zone A[2, 4], since difference between the maximum value and the minimum value of a luminance signal is mainly small, the luminance-signal difference value D[2, 4] of the focus detection zone A[2, 4] takes a small value. However, after the outline of the house 502 enters in the focus detection zone A[2, 4], the difference between the maximum value and the minimum value of the luminance signals of the focus detection zone A[2, 4] increases because of the outline of the house 502, which increases the luminance-signal difference value D[2, 4].

Next, since the person 501 is mainly focused at the lens position LP3 in the focus detection zone A[3, 3], the focus evaluation value E[3, 3] takes the local maximum near the lens position LP3.

On the other hand, since the outline of the person 501 is always included in the focus detection zone A[3, 3] regardless of the position of the focus lens group 3, the luminance-signal difference value D[3, 3] of the focus detection zone A[3, 3] slightly varies with the lens position and takes almost a constant value.

Next, since the person 501 who slightly enters in the focused detection area A[4, 2] is mainly focused at the lens position LP3, the focus evaluation value E[4, 2] increases as the lens moves toward the lens position LP3. However, the outline of the door of the house 503 moves toward the focus detection zone A[4, 2] as the focusing state closes to the in-focus condition, and the outline of the door of the house 503 enters in the focus detection zone A[4, 2] when the focusing lens group 3 is positioned at the lens position LP3 or nearer.

Here is assumed that the outline of the door of the house 503 is brighter in luminance and higher in contrast than the outline of the person 501. Accordingly, the focus evaluation value E[4, 2] once decreases as the person 501 blurs at the near side of the lens position LP3, but the focus evaluation value E[4, 2] increases again because the outline of the door of the house 503 enters in the focus detection zone A[4, 2].

Then, the focus evaluation value E [4, 2] decreases as the outline of the door of the house 503 further blurs. In such a case, the local maximum under the influence of the person 501 is formed near the lens position LP3, and the local maximum under the influence of the outline of the door of the house 503 is formed in the nearer side of the lens position LP4.

On the other hand, the luminance-signal difference value D[4, 2] of the focus detection zone A[4, 2] takes a low value when the focus detection zone A[4, 2] includes only the person 501. Then, the luminance-signal difference value D[4, 2] increases in connection with the outline of the door of the house 503 entering in the focus detection zone A[4, 2]. When the outline of the door of the house 503 has entered in the focus detection zone A[4, 2], the luminance-signal difference value D[4, 2] takes a stable value.

As mentioned above, the variations of the focus evaluation value E and the luminance-signal difference value D differ from one focus detection zone to another. Although the focus evaluation values E of all the above-mentioned focus detection zones A[2, 4], A[3, 3], and A[4, 2] take the local maximum values, only the focus evaluation value E[3, 3] of the focus detection zone A[3, 3] takes the local maximum value that correctly shows the in-focus position.

Since the focus evaluation value E[2, 4] of the focus detection zone A[2, 4] is affected by the outline of the house 502 that enters in the focus detection zone due to the variation of image magnification during AF scan, the focus evaluation value E[2, 4] takes the local maximum value near the lens position LP3. Moreover, since the focus evaluation value E[4, 2] of the focus detection zone A[4, 2] is affected by the outline of the door of the house 503 that enters in the focus detection zone due to the variation of image magnification during AF scan, the focus evaluation value E[4, 2] takes the local maximum value in the nearer side of the lens position LP4.

Thus, it is difficult to determine the local maximum value that correctly shows the in-focus position based on only the change curve of the focus evaluation value E.

Accordingly, this embodiment determines the local maximum value that correctly shows the in-focus position using variation of the luminance-signal difference value D. The luminance-signal difference values D[2, 4] and D[4, 2] of the focus detection zones A[2, 4] and A [4, 2] among the focus detection zones A[2, 4], A[3, 3], and A[4, 2] vary significantly.

This is because the outline of the house 502 moves due to variation of image magnification in the focus detection zone A[2, 4] and the outline of the door of the house 503 moves due to variation of image magnification in the focus detection zone A[4, 2]. A degree of the reliability of the local maximum value of the focus evaluation value E of the focus detection zones is determined using the reliability evaluation value R[h, v] obtained by the above formula (3).

Since the reliability evaluation value R[h, v] is an amount of change of the luminance-signal difference value D[n][h, v] due to a positional change of the focus lens group 3, it corresponds to the inclination component of the curve of the luminance-signal difference value D shown in FIG. 8B. A threshold value is set to this inclination component. As a result, it is determined that the focus detection zone A[3, 3] is high in the degree of the reliability of the local maximum value of the focus evaluation value E.

On the other hand, it is determined that the focus detection zones A[2, 4] and A[4, 2] are low in the degree of the reliability of the local maximum value of the focus evaluation value E. In the above formula (3), the amount of change of the luminance-signal difference value D at the continuous positions of the focus lens group 3 is used as the reliability evaluation value R. The reliability evaluation value R may be calculated using the luminance-signal difference value D after the low pass filtering process has been applied in order to avoid the influence of high frequency noise of the luminance-signal difference value D.

The description returns to FIG. 5. The CPU 15 determines whether the reliability evaluation values have been calculated for all the zones in the entire focus detection area 504 in step S32. When the reliability evaluation values have been calculated for all the areas in the entire focus detection area 504, the process proceeds to step S33. Otherwise, the process returns to the step S31.

The CPU 15 sets up a threshold value for evaluating reliability of a focus detection zone in step S33, and proceeds with the process to step S34. The threshold here is set up for every focus detection zone based on the maximum value of the luminance signal in the focus detection zone obtained in the step S2. In addition, this threshold value may be set up based on the total sum of the luminance signals in a focus detection zone, or may be set as a fixed value defined beforehand.

In step S34, the CPU 15 determines whether the reliability evaluation value R calculated in the step S31 is less than the threshold value calculated in the step S33. When the reliability evaluation value R calculated in the step S31 is less than the threshold value calculated in the step S33, the CPU 15 proceeds with the process to step S35. Otherwise the process proceeds to step S36.

The CPU 15 sets the focus detection zone concerned as a focus detection zone with high reliability in the step S35, and proceeds with the process to step S37.

On the other hand, the CPU 15 sets the focus detection zone concerned as a focus detection zone with low reliability in the step S36, and proceeds with the process to the step S37.

Then, the CPU 15 determines whether the determinations for all the focus detection zones have been completed in the step S37. When the determinations have not completed, the CPU 15 returns the process to the step S34, and when the determinations have been completed, the CPU 15 finishes the reliability evaluation process for the focus detection zones.

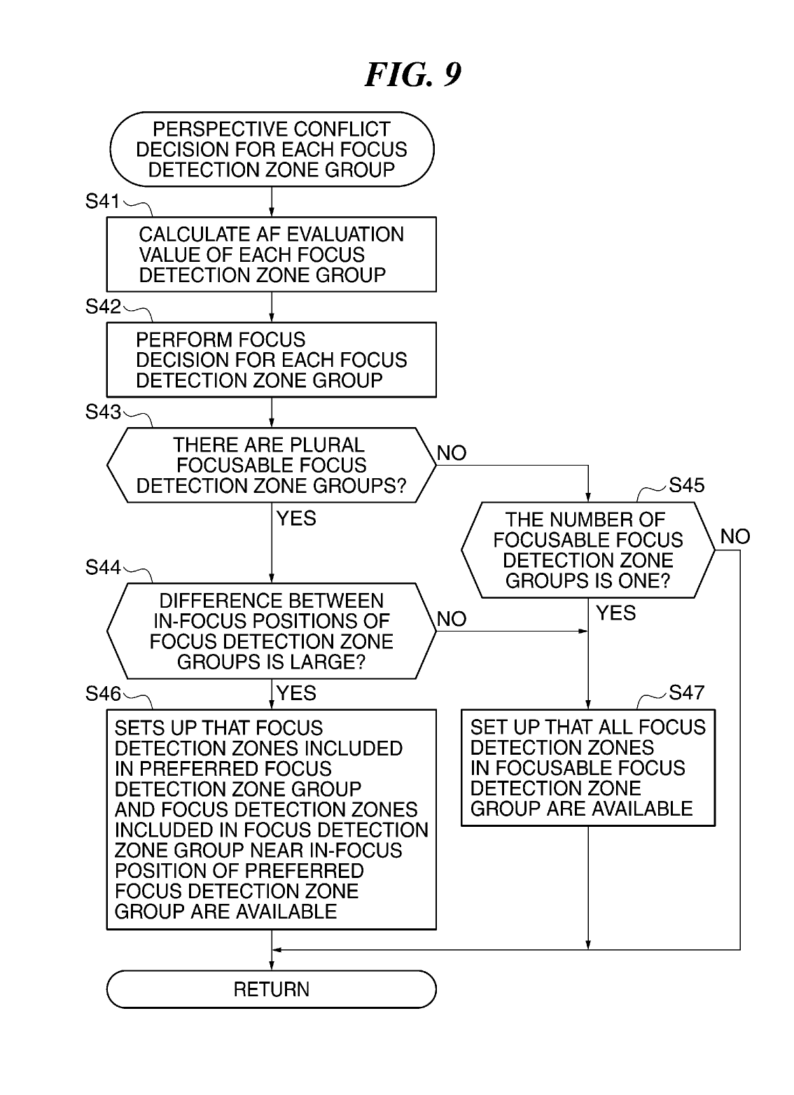

Next, a concrete process of the perspective conflict decision of the focus detection zone groups in the step S4 in FIG. 2 will be described with reference to FIG. 9.

As shown in FIG. 9, the CPU 15 calculates the AF evaluation value of each focus detection zone group in step S41, and proceeds with the process to step S42. In this embodiment, the outer peripheral focus detection zone group 506 and the central focus detection zone group 507 are set up as the focus detection zone groups as mentioned above (FIG. 4A). The AF evaluation value of each of the focus detection zone groups 506 and 507 is calculated as the total sum of the focus evaluation values E of the focus detection zones that constitute the focus detection zone group at each position of the focus lens group 3.

FIG. 10 is a graph showing relationships between the AF evaluation values of each of the focus detection zone groups 506 and 507 and the position of the focus lens group 3. In FIG. 10, the lens positions LP1, LP2, LP3, and LP4 correspond to the positions of the focus lens group 3 at the states shown in FIG. 6A, FIG. 6B, FIG. 7A, and FIG. 7B, respectively.

The AF evaluation value AF_S of the outer peripheral focus detection zone group 506 is affected by the houses 502 and 503 shown in FIG. 6A, FIG. 6B, FIG. 7A, and FIG. 7B, and takes the largest local maximum value near the lens position LP2. Since the central focus detection zone group 507 mainly includes only the person 501, the AF evaluation value AF_C of the central focus detection zone group 507 takes the local maximum value at the lens position LP3 where the person 501 comes into focus.

The CPU 15 performs the focus decision for each focus detection zone group using the AF evaluation values in the step S42, and proceeds with the process to step S43. The process in the step S42 is the same as that in the step S8 in FIG. 2. That is, the in-focus position of the focus lens group 3 is calculated and the reliability of the AF evaluation value curve is evaluated.

In step S43, the CPU 15 determines whether there are plural focusable focus detection zone groups based on the result of the focus decision in the step S42. Then, when the number of focusable focus detection zone groups is one or zero, the CPU 15 proceeds with the process to step S45. When the number of focusable focus detection zone groups is plural, the CPU 15 proceeds with the process to step S44.

In the step S45, the CPU 15 determines whether the number of focusable focus detection zone groups is one. Then, when determining that the number of focusable focus detection zone groups is one, the CPU 15 proceeds with the process to step S47. When determining that the number of focusable focus detection zone groups is not one, the CPU 15 finishes the process without setting any focus detection zone group as an effective focus detection zone that can be used because there is no focusable focus detection zone group.

In the step S47, the CPU 15 sets up that all the focus detection zones in the focusable focus detection zone group determined in the step S45 are available, and finishes the process.

On the other hand, the CPU 15 determines whether the difference between the in-focus positions of the focus detection zone groups is large in the step S44. Then, when the difference between the in-focus positions of the focus detection zone groups is small, the CPU 15 proceeds with the process to the step S47, sets up that all the focus detection zones in the focusable focus detection zone groups are available, and finishes the process. When the difference between the in-focus positions is large, the CPU 15 proceeds with the process to step S46.

The CPU 15 sets up that focus detection zones included in a preferred focus detection zone group and focus detection zones included in a focus detection zone group near the in-focus position of the preferred focus detection zone group are available in the step S46, and finishes the process.

Here, the preferred focus detection zone group will be described with reference to FIG. 6A, FIG. 6B, FIG. 7A, FIG. 7B, and FIG. 10. In FIG. 10, the lens positions LP1, LP2, LP3, and LP4 correspond to the positions of the focus lens group 3 at the states shown in FIG. 6A, FIG. 6B, FIG. 7A, and FIG. 7B, respectively.

In the states shown in FIG. 6A, FIG. 6B, FIG. 7A, and FIG. 7B, the AF evaluation value AF_C of the central focus detection zone group 507 and the AF evaluation value AF_S of the outer peripheral focus detection zone group 506 vary as shown in FIG. 10. That is, the in-focus positions of the focus lens group 3 are different with each other. However, the AF evaluation values AF_C and AF_S of both of the focus detection zone groups have the local maximum values, and the shapes of the AF evaluation values near the local maximum values have reliability.

Accordingly, in the states shown in FIG. 6A, FIG. 6B, FIG. 7A, and FIG. 7B, the CPU 15 determines in the step S43 in FIG. 9 that there are plural (two) focus detection zone groups 506 and 507. Moreover, since the difference between the in-focus positions of the two focus detection zone groups 506 and 507 corresponds to the difference between the lens positions LP3 and LP2, the CPU 15 determines that the difference is large in the step S44. As a result, the central focus detection zone group 507 is set in the step S46 as a preferred focus detection zone group in which a main subject intended by a photographer exists at a high probability in general.

Moreover, in the states shown in FIG. 6A, FIG. 6B, FIG. 7A, and FIG. 7B, there is no other focus detection zone group that has the local maximum value near the lens position LP3 that is the in-focus position of the preferred focus detection zone group. Accordingly, the CPU 15 sets only the focus detection zones that constitute the central focus detection zone group 507 as available, and finishes the perspective conflict decision process for the focus detection zone groups.

Although this embodiment performs the perspective conflict decision after generating the focus detection zone groups by grouping the focus detection zones, the determining method of the perspective conflict is not limited to the method of the embodiment. For example, when one focus detection zone is enough to evaluating an in-focus position, the perspective conflict decision may be performed among focus detection zones. Moreover, although the central focus detection zone group was used as the preferred focus detection zone group in the embodiment, the priority may be given to a focus detection zone based on a subject detection result in the area or to a focus detection zone with a large focus evaluation value.

As mentioned above, this embodiment extracts a focus detection zone where an influence on the AF due to movement of a subject during the AF scan and an influence on the AF given by a subject outside the focus detection zone due to variations of image magnification and defocus are small, by evaluating reliability of each focus detection zone in the step S3 in FIG. 2. Moreover, the focus detection zone including the subject intended by a photographer is extracted by excepting the focus detection zones that cause the perspective conflict in the entire focus detection area 504 in the step S4.

Next, the effective focus detection zones extracted in both the steps S3 and S4 will be described with reference to FIG. 11A and FIG. 11B in view of the comparison with FIG. 3A (this embodiment) and FIG. 3B (comparative example).

FIG. 11A is a view showing focus detection zones that are not extracted from the focus detection zones shown in FIG. 3A in the steps S3 and S4 in FIG. 2.

In FIG. 11A, the focus detection zones that are not extracted in the step S3 are illustrated by vertical hatching, and the focus detection zones that are not extracted in the step S4 are illustrated by horizontal hatching. Moreover, the focus detection zones that are not extracted in both the steps S3 and S4 are illustrated by latticed hatching. As a result, in the states in FIG. 6A, FIG. 6B, FIG. 7A, and FIG. 7B, focus decision etc. are performed using the focus evaluation values of the seven focus detection zones that are not hatched in FIG. 11A.

On the other hand, FIG. 11B is a view showing focus detection zones that are not extracted from the focus detection zones shown in FIG. 3B in the steps S3 and S4 in FIG. 2.

In FIG. 11B, the focus detection zones that are not extracted in the step S3 are illustrated by vertical hatching, and the focus detection zones that are not extracted in the step S4 are illustrated by horizontal hatching in the same manner as shown in FIG. 11A. Moreover, the focus detection zones that are not extracted in both the steps S3 and S4 are illustrated by latticed hatching. As a result, in the states in FIG. 6A, FIG. 6B, FIG. 7A, and FIG. 7B, focus decision etc. are performed using the focus evaluation values of the three focus detection zones (the second through fourth lines of the third column) that are not hatched in FIG. 11B.

As mentioned above, although this embodiment uses the seven focus detection zones with high reliability to calculate the focus evaluation value, the comparative example uses only three focus detection zones. This is because there are many subjects that have contrast in the horizontal direction as ordinary subjects in the states shown in FIG. 6A, FIG. 6B, FIG. 7A, and FIG. 7B.

Specifically, the outline of the house 502 and the outline of the door of the house 503 have contrast horizontally with vertical boundaries. The boundaries with contrast affect the focus detection zones in the first, second, fourth, and fifth column within the entire focus detection area 504, and they are determined as unreliable focus detection zones.

On the other hand, in this embodiment, as mentioned above, the entire focus detection area 504 that is divided into M (=5*5) focus detection zones is set up in the center of the image pickup screen 500, and the focus detection zones are arranged so that the position of each line is shifted in the X direction (horizontal direction) with respect to the adjacent line. This can reduce the number of the focus detection zones that are affected by the vertical boundaries, such as the outline of the house 502 and the outline of the door of the house 503. Thereby, many reliable focus detection zones are available, and the focus detection accuracy is improved as a result.

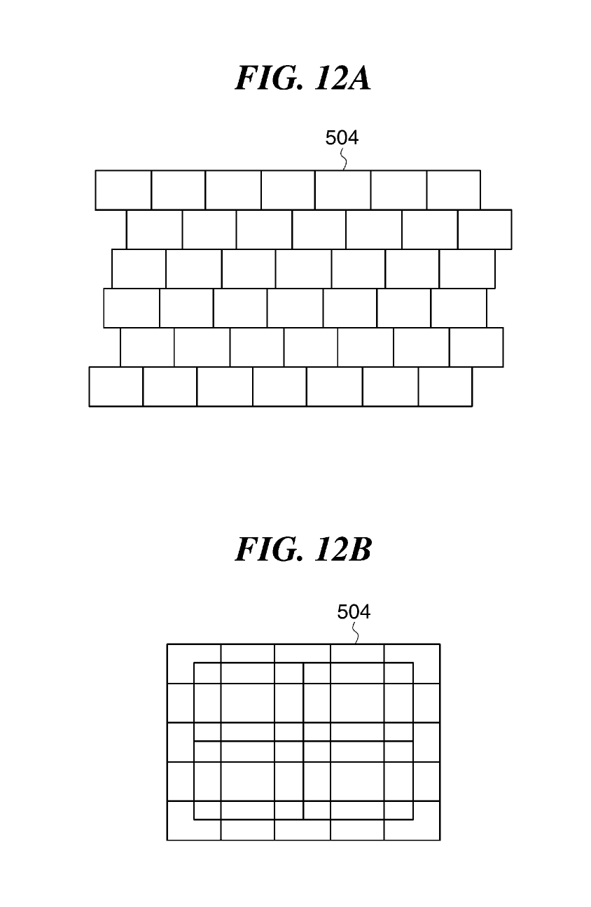

Next, modifications of arrangement of the focus detection zones in the entire focus detection area will be described with reference to FIG. 12A and FIG. 12B. FIG. 12A is a view showing the entire focus detection area 504 divided into M (=6*7) focus detection zones. As shown in FIG. 12A, the focus detection zones are arranged so that the positions of the respective lines are deviated with one another in the X direction (the horizontal direction) by integral multiple of a width that is obtained by dividing the width of one focus detection zone by the number of lines (=6) in the same manner as shown in FIG. 3A. The focus detection zones in the entire focus detection area 504 shown in FIG. 3A are arranged in a parallelogram shape. On the other hand, the focus detection zones in the entire focus detection area 504 shown in FIG. 12A are arranged in an approximately rectangular shape.

The reduction effect to the influence on the horizontal contrast of a subject with the arrangement in FIG. 12A is not different from that in FIG. 3A. On the other hand, a focus detection area that a photographer recognizes is a focus detection frame displayed on the display unit 10, and the focus detection frame is rectangle in general. Accordingly, the arrangement of the focus detection zones shown in FIG. 12A can reduce the difference between the focus detection area that a photographer recognizes and the area that is actually used for focusing.

FIG. 12B is a view showing the entire focus detection area 504 that is formed by superimposing focus detection zones divided into M (=2*2) zones on focus detection zones divided into M (=5*5) zones. Such an arrangement of the focus detection zones avoids the influence on the superimposed focus detection zones even when an outline of a subject moves over a boundary between the focus detection zones. Accordingly, many reliable focus detection zones are secured while the focus detection zones divided into M (=5*5) zones and the focus detection zones divided into M (=2*2) zones are complemented mutually, which improves the focus detection accuracy.

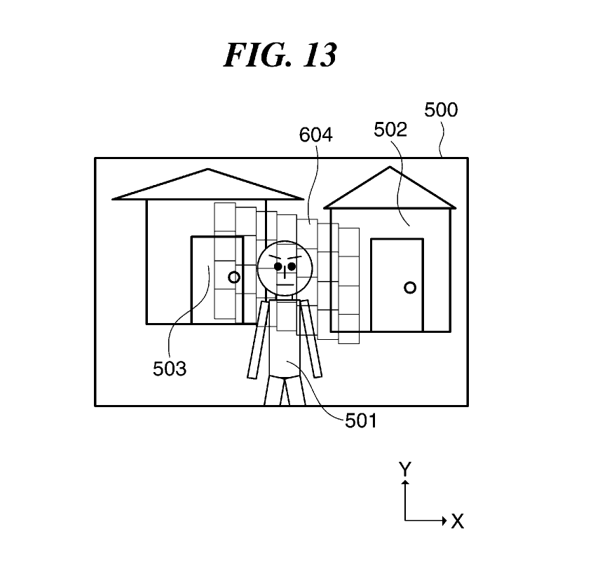

Next, a second embodiment of the present invention will be described. Although the first embodiment is described on the precondition that the high-frequency component is extracted in the horizontal direction, the present invention is not limited to this. In the second embodiment, the high-frequency component is extracted in the vertical direction, and focus detection zones are arranged so that the positions of the respective columns are deviated with one another in the Y direction. FIG. 13 shows an example in which the respective columns of the focus detection zones are deviated with one another in the Y direction. As shown in FIG. 13, the entire focus detection area 604 that is divided into M (=7*4) zones is set up in the center in the image pickup screen 500, and the positions of the respective columns are deviated with one another in the Y direction (the vertical direction). This arrangement avoids the influence of the boundaries in the horizontal direction, such as the bottom outline of the house 502 and the upper outline of the door of the house 503, and increases the number of the reliable focus detection zones.

Next, a third embodiment of the present invention will be described. Although the first and second embodiments describe the cases where the high-frequency component is extracted in one of the horizontal and vertical directions, the present invention is not limited to this. The third embodiment enables to select the direction in which the high-frequency component is extracted from the horizontal direction and the vertical direction. Moreover, the high-frequency components can be extracted in both of the horizontal direction and the vertical direction.

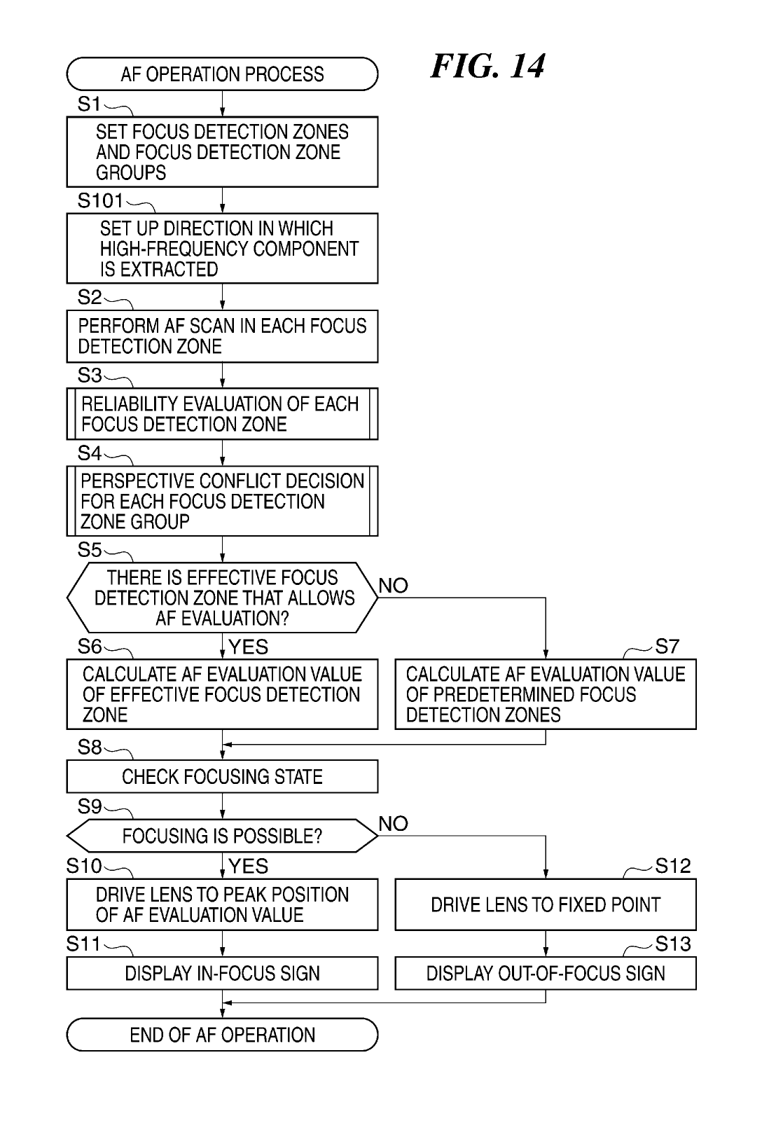

FIG. 14 is a flowchart showing an AF operation of a digital still camera that is provided with a focus detecting device according to the third embodiment of the present invention. Each process in FIG. 14 is achieved by loading a control program stored in the ROM etc. onto a RAM and by executing the program by the CPU 15.

It should be noted that a step in FIG. 14 in which the same process as the step in FIG. 2 is executed is represented by the same reference number. The process in FIG. 14 differs from FIG. 2 in that a process in step S101 for selecting and setting a direction in which a high-frequency component is extracted is added after the step S1.

As shown in FIG. 14, when the AF operation is started, the CPU 15 sets up the focus detection zones and focus detection zone groups for focusing on a subject first in the step S1, and proceeds with the process to the step S101. In the process in this step S1, M (=m_h*m_v, m_h=1, 2, . . . , m_v=1, 2, . . . ) focus detection zones are set up in an image pickup screen in order to extract a horizontal high-frequency component. Furthermore, N (=n_h*n_v, n_h=1, 2, . . . , n_v=1, 2, . . . ) focus detection zones are set up in the image pickup screen in order to extract a vertical high-frequency component.

In each of the focus detection zones, a plurality of pickup pixels are two-dimensionally arranged in the line direction and the column direction. Then, the number of pixels arranged in each focus detection zone is identical.

The arrangement of the M focus detection zones for extracting the horizontal high-frequency components is the same as that described with reference to FIG. 3A. Moreover, the arrangement of the N focus detection zones for extracting the vertical high-frequency components is the same as that described with reference to FIG. 13. Namely, in the third embodiment, first and second focus detection zones that adjoin in a first direction (vertical direction) among the focus detection zones are arranged so as to be deviated with each other in a second direction (horizontal direction) as shown in FIG. 3A in order to generate a contrast focus evaluation value that evaluates an image signal in the second direction. Moreover, in the third embodiment, first and second focus detection zones that adjoin in the second direction (horizontal direction) among the focus detection zones are arranged so as to be deviated with each other in the first direction (vertical direction) as shown in FIG. 13 in order to generate a contrast focus evaluation value that evaluates an image signal in the first direction. Focus detection zone groups are also set up as well as the above-mentioned descriptions.

Next, the direction in which a high-frequency component is extracted is set up in the step S101. Here, focus evaluation values and luminance-signal difference values are calculated for the M focus detection zones from which the horizontal high-frequency components are extracted and the N focus detection zones from which the vertical high-frequency components are extracted. Then, the focus detection zones that extract the high-frequency components in the direction that is larger in the averages of the focus evaluation values and the luminance-signal difference values obtained therefrom are selected.

Here, although the direction in which the high-frequency component is extracted is set during AF operation, it may set up in advance. When the camera is in a live view state where a picked up image is displayed on the display unit 10 before starting the AF operation, the focus detection zones from which suitable high-frequency components in the horizontal and vertical directions are extracted in the live view state may be set up, and the direction in which the high-frequency component is extracted may be set based on the focus evaluation value and the luminance-signal difference value that are obtained.

Moreover, when the direction in which the high-frequency component is extracted is set, a dividing state of focus detection zones may differ from that in an AF operation in future. For example, a focus detection zone may be set for each of the horizontal and vertical directions in which high-frequency components are extracted without dividing a focus detection area.

Moreover, the method of setting a direction in which a high-frequency component is extracted is not limited to the above-mentioned embodiments. It may be set according to an orientation of the camera, for example. The processes after the step S101 are similar to the processes shown in FIG. 2.

Thus, even when a subject has contrast in only one direction like a blind, suitable focus detection zones can be set up and focus can be adjusted with high accuracy by enabling to select a direction in which a high-frequency component is extracted.

Next, the case where high-frequency components are extracted in both of the horizontal and vertical directions will be described. In such a case, both the M focus detection zones that are arranged as shown in FIG. 3A and are used to extract the horizontal high-frequency components and the N focus detection zones that are arranged as shown in FIG. 13 and are used to extract the vertical high-frequency components are set up in the step S1 in FIG. 2. Then, the process that is similar to that in FIG. 2 is applied to each of the M focus detection zones and the N focus detection zones individually, and the focus decision is performed using two kinds of AF evaluation values in the step S8.

In the step S8, it is determined whether the AF evaluation value obtained from the M focus detection zones from which the horizontal high-frequency components are extracted has the local maximum value, and the reliability is evaluated as mentioned above. Then, it is determined whether the AF evaluation value obtained from the N focus detection zones from which the vertical high-frequency components are extracted has the local maximum value, and the reliability is evaluated as mentioned above.

As a result, when the local maximum value of the reliable AF evaluation values is obtained from the focus detection zones in only one direction, the position of the focus lens group 3 corresponding to the maximum value in the obtained direction is calculated, and the process proceeds to the step S9.

On the other hand, when the local maximum values of the reliable AF evaluation values are obtained from the focus detection zones in both the directions, the positions of the focus lens group 3 corresponding to the maximum values in both the directions are calculated respectively, and the position of the focus lens group 3 is determined by performing a weighted average process for the two positions of the focus lens group 3. In the weighted average process, the positions of the focus lens group 3 are weighted according to the ratio of the local maximum values in the respective directions in which high-frequency components are extracted, and then, an average of the weighted positions is calculated.

When there are a plurality of directions in which high-frequency components are extracted, the camera can focus on a subject that has contrast in only one direction. Moreover, an image formation position varies depending on a direction of contrast of a subject due to aberration, such as astigmatism of an image pickup optical system, in general. As mentioned above, when the weighted average process is applied to the local maximum values of the AF evaluation values obtained by extracting the high-frequency components in the two directions, the focus can be adjusted to a subject having contrast in a plurality of directions while reducing the influence of the difference between the image formation positions.

When the local maximum values of reliable AF evaluation values are obtained in the focus detection zones of both the directions, the focus detection zone from which the larger local maximum value was obtained may be selected, and the position of the focus lens group 3 may be calculated based on the larger local maximum value. Thereby, the focus can be adjusted to a subject having contrast in a plurality of directions more simply while reducing the influence of the difference between the image formation positions.

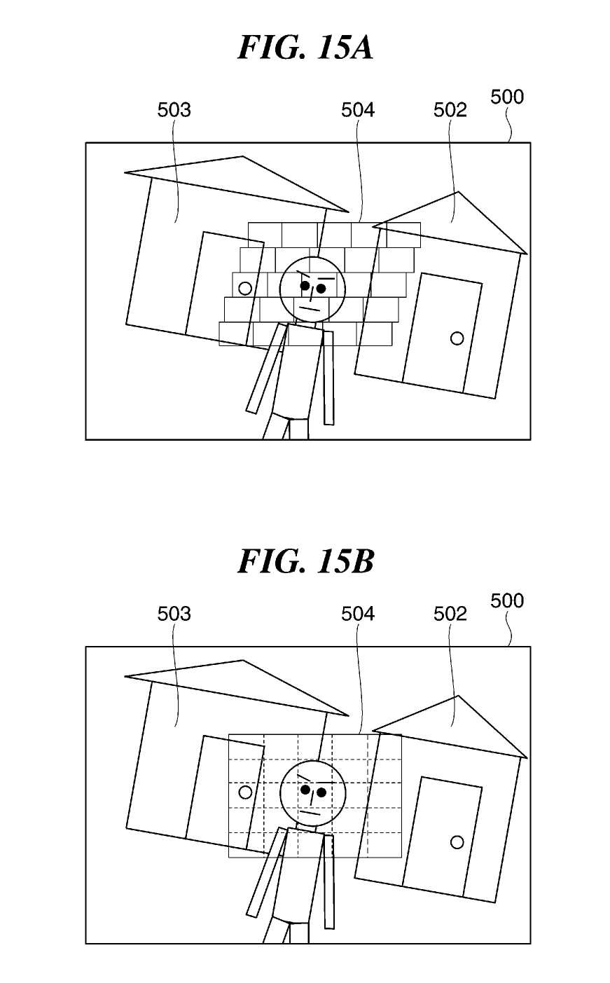

Next, a digital still camera equipped with a focusing device according to a fourth embodiment of the present invention will be described with reference to FIG. 15.

It should be noted that descriptions for sections common to the first embodiment will be omitted, and only different sections will be described while diverting the drawings and the reference numerals.

Although the focus detection zones are arranged on the precondition that many subjects generally have contrast in horizontal or vertical direction in the above-mentioned first embodiment, such an arrangement may decrease focus detection accuracy when a boundary of a subject is coincident with the boundaries of the focus detection zones that are arranged with deviations.

In this embodiment, the focus detection zones are arranged according to a direction of a boundary with contrast of a subject so as to obtain more signal quantity according to the pattern of the subject. Accordingly, the reliability of the focus detection zones can be determined more accurately, and the deterioration of S/N ratio of the AF evaluation value due to unnecessary elimination of focus detection zones can be prevented.

In this embodiment, the setting process of the focus detection zones in the step S1 in FIG. 2 is different from the above-mentioned first embodiment. Details will be described hereafter.

In the step S1 in FIG. 2, the CPU 15 sets up focus detection zones and focus detection zone groups for focusing on a subject. In the process in this step S1, M focus detection zones (M=m_h*m_v (m_h=1, 2, . . . , m_v=1, 2, . . . )) are set in an image pickup screen. In each of the focus detection zones, a plurality of pickup pixels are two-dimensionally arranged. Then, the number of pixels arranged in each focus detection zone is identical.

FIG. 15A is a view showing a state where the entire focus detection area 504 that is divided into M (=5*5) zones is set in the center in the image pickup screen 500. In FIG. 15A, the subject is the same as that in FIG. 3A, and a composition is formed by inclining the camera according to the photographer's intention. In FIG. 15A, the focus detection zones are deviated in the X direction for every line in the same manner as shown in FIG. 3A.

In FIG. 15A, the outline of the subject that is intentionally inclined is coincident with the deviation amount of the focus detection zones. If focus is adjusted in such a state, the number of reliable focus detection zones decreases because many focus detection zones are affected by movement of the subject and variation of defocus condition in the same manner as shown in FIG. 3B.

On the other hand, when the deviation amount for every line of the focus detection zones is set so that the boundaries among the focus detection zones are not parallel to the edge direction of the outline of the subject, the focus detection zones are not affected as mentioned above and many reliable focus detection zones can be obtained. It should be noted that the example shown in FIG. 15B is a comparative example in which the deviation amount among the focus detection zones is zero.

In this embodiment, the edge direction of the outline of the subject in the entire focus detection area 504 is detected and the focus detection zones are set up according to the detected edge direction in the step S1 in FIG. 2.

The edge direction of a subject can be detected using the well-known technique (for example, the technique shown in FIG. 8 of Japanese Laid-Open Patent Publication (Kokai) No. 2011-145559 (JP 2011-145559A)). It should be noted that the edge direction may be detected using output signals of a regular image pickup device used for focusing in place of the focus detection pixels.

After detecting the edge direction, the CPU 15 sets up the deviation amount for every line of the focus detection zones so that the boundaries among the focus detection zones in the X direction are not parallel to the detected edge direction.

In addition, the deviation amount and the division number the of focus detection zones may be changed according to a subject. When the division number is maintained in the case where the size of a subject is small, the size of each focus detection zone becomes small, which may deteriorate an S/N ratio of the focus evaluated value obtained. Accordingly, the minimum area of the focus detection zone may be set and the division number may be set so that the focus detection zone is larger than the minimum area. Moreover, when the detected edge is a curve, the deviation amount may vary according to the curved edge.

As mentioned above, since this embodiment detects the edge direction of a subject in a focus detection area and sets up the focus detection zones according to the detected edge direction, the number of reliable focus detection zones increases, and the focus detection accuracy is improved regardless of a pattern of the subject. The other configurations and operation effects are the same as that of the above-mentioned first embodiment.

It should be noted that the present invention is not limited to what has been described with the above-mentioned embodiments, and can be changed suitably unless it is deviated from the scope of the present invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-237745, filed on Oct. 29, 2012, and No. 2013-217837, filed on Oct. 18, 2013 which are hereby incorporated by reference herein in its entirety.

What is claimed is:

1. An image pickup apparatus comprising:
an image pickup device configured to photoelectrically convert an optical image formed by light entering through an image pickup optical system into an image signal, and to output the image signal;
an arrangement unit configured to arrange a plurality of focus detection zones like a lattice in a first direction and a second direction that differs from the first direction with respect to said image pickup device;
a generation unit configured to generate a contrast focus evaluation value that evaluates image signals of pixels of said image pickup device corresponding to each of the focus detection zones in the second direction;
a reliability decision unit configured to determine reliability of each of the focus detection zones using the image signal; and
a focusing unit configured to adjust focus of the image pickup optical system based on the contrast focus evaluation value based on an image signal of a focus detection zone of which reliability is more than a specified value among the focus detection zones,
wherein said arrangement unit arranges the focus detection zones so that at least one boundary of a first focus detection zone in the second direction is included within an area of a second focus detection zone in the second direction, wherein the first and second focus detection zones are included in focus detection zones arranged in the first direction, wherein the first and second focus detection zones are deviated with one another in the first direction.

2. The image pickup apparatus according to claim 1, wherein the focus detection zones are arranged so that the positions of respective lines in the second direction are deviated with one another in the second direction, and that the deviation amount between different lines in the second direction is set so as to be integral multiple of a width that is obtained by dividing a width of one focus detection zone by the number of lines.

3. The image pickup apparatus according to claim 1, further comprising:
a detection unit configured to detect an edge direction of the optical image,
wherein each of the focus detection zones is a rectangle, and said arrangement unit arranges the focus detection zones so that boundaries among the focus detection zones in the second direction are not parallel to the edge direction detected by said detection unit.

4. The image pickup apparatus according to claim 1, wherein said arrangement unit arranges first and second focus detection zones that adjoin in the first direction among the focus detection zones so as to be deviated with each other in the second direction, when generating a contrast focus evaluation value that evaluates image signals of pixels of said image pickup device corresponding to each of the focus detection zones in the second direction, and
wherein said arrangement unit arranges first and second focus detection zones that adjoin in the second direction among the focus detection zones so as to be deviated with each other in the first direction, when generating a contrast focus evaluation value that evaluates image signals of pixels of said image pickup device corresponding to each of the focus detection zones in the first direction.

5. An image pickup apparatus comprising:
an image pickup device configured to photoelectrically convert an optical image formed by light entering through an image pickup optical system into an image signal, and to output the image signal;
an arrangement unit configured to arrange a plurality of focus detection zones like a lattice in a first direction and a second direction that differs from the first direction with respect to said image pickup device;
a generation unit configured to generate a contrast focus evaluation value that evaluates image signals of pixels of said image pickup device corresponding to each of the focus detection zones in the second direction;
a reliability decision unit configured to determine reliability of each of the focus detection zones using the image signal; and
a focusing unit configured to adjust focus of the image pickup optical system based on the contrast focus evaluation value based on an image signal of a focus detection zone of which reliability is more than a specified value among the focus detection zones,
wherein the first and second focus detection zones that adjoin in the first direction among the focus detection zones are deviated with each other in the second direction.

6. The image pickup apparatus according to claim 5, wherein the focus detection zones are arranged so that the positions of respective lines in the second direction are deviated with one another in the second direction.

7. The image pickup apparatus according to claim 6, wherein the deviation amount between different lines in the second direction is set so as to be integral multiple of a width that is obtained by dividing a width of one focus detection zone by the number of lines.

8. The image pickup apparatus according to claim 5, further comprising:
a detection unit configured to detect an edge direction of the optical image,
wherein each of the focus detection zones is a rectangle, and said arrangement unit arranges the focus detection zones so that boundaries among the focus detection zones in the second direction are not parallel to the edge direction detected by said detection unit.

9. The image pickup apparatus according to claim 5, wherein said arrangement unit arranges first and second focus detection zones that adjoin in the first direction among the focus detection zones so as to be deviated with each other in the second direction, when generating a contrast focus evaluation value that evaluates image signals of pixels of said image pickup device corresponding to each of the focus detection zones in the second direction, and
wherein said arrangement unit arranges first and second focus detection zones that adjoin in the second direction among the focus detection zones so as to be deviated with each other in the first direction, when generating a contrast focus evaluation value that evaluates image signals of pixels of said image pickup device corresponding to each of the focus detection zones in the first direction.

10. A control method for an image pickup apparatus comprising:
an arrangement step of arranging a plurality of focus detection zones like a lattice in a first direction and a second direction that differs from the first direction with respect to an image pickup device, which photoelectrically converts an optical image formed by light entering through an image pickup optical system into an image signal;
a generation step of generating a contrast focus evaluation value that evaluates image signals of pixels of said image pickup device corresponding to each of the focus detection zones in the second direction;
a reliability decision step of determining reliability of each of the focus detection zones using the image signal; and
a focusing step of adjusting focus of the image pickup optical system based on the contrast focus evaluation value based on an image signal of a focus detection zone of which reliability is more than a specified value among the focus detection zones,
wherein the focus detection zones are arranged in said arrangement step so that at least one of two boundaries of a first focus detection zone in the second direction is included within an area of a second focus detection zone in the second direction, wherein the first and second focus detection zones are included in focus detection zones arranged in the first direction, wherein the first and second focus detection zones are deviated with one another in the first direction.

11. A control method for an image pickup apparatus comprising:
an arrangement step of arranging a plurality of focus detection zones like a lattice in a first direction and a second direction that differs from the first direction with respect to an image pickup device, which photoelectrically converts an optical image formed by light entering through an image pickup optical system into an image signal;
a generation step of generating a contrast focus evaluation value that evaluates image signals of pixels of said image pickup device corresponding to each of the focus detection zones in the second direction;
a reliability decision step of determining reliability of each of the focus detection zones using the image signal; and
a focusing step of adjusting focus of the image pickup optical system based on the contrast focus evaluation value based on an image signal of a focus detection zone of which reliability is more than a specified value among the focus detection zones, wherein the first and second focus detection zones that adjoin in the first direction among the focus detection zones are deviated with each other in the second direction.
